(19) United States
(12) Patent Application Publication
(10) Pub. No.: US 2022/0172209 A1
(43) Pub. Date: Jun. 2, 2022

(54) DIRECT EXTENDED REACH SYSTEM AND METHOD

(71) Applicant: VISA INTERNATIONAL SERVICE ASSOCIATION, San Francisco, CA (US)

(72) Inventors: Matthew G. Vanhouten, San Francisco, CA (US); Sunil Joshi, Foster City, CA (US); Vanitchand Shah, London (GB); Greg Loomis, Foster City, CA (US); Daniel Mottice, Palo Alto, CA (US); Vikram Modi, San Francisco, CA (US); William Sheley, Ashburn, VA (US); Dong Xiao, Austin, TX (US)

(21) Appl. No.: 17/442,521

(22) PCT Filed: Jun. 5, 2020
(86) PCT No.: PCT/US20/36366

§ 371 Date: Sep. 23, 2021

Related U.S. Application Data
(60) Provisional application No. 62/858,105, filed on Jun. 6, 2019.

(51) Int. Cl. G06Q 20/40; G06Q 20/02; G06Q 20/10

(52) U.S. Cl. CPC G06Q 20/4012; G06Q 20/4016; G06Q 20/108; G06Q 20/102; G06Q 20/023

(57) ABSTRACT

Transactions between account-based endpoints are performed in a two-step process that first qualifies the recipient's validity and then performs the actionable transfer. The qualification step, unlike a payment pre-qualification, validates the recipient account validity while collecting information required for filling out a transaction data set. The information may include anti-money laundering and know-your-customer information as well as specific account details needed for on-boarding. A recipient payouts service provider may be assigned a tokenized bank identification number for use in routing the transfer through existing financial processing networks. Data constructs, minimum required information, and format checks may be facilitated by initiator-side and recipient-side application program interfaces.

### CROSS-REFERENCE TO RELATED APPLICATION

This application is filed under the Patent Cooperation Treaty claiming priority to U.S. provisional application No. 62/858,105 filed on Jun. 6, 2019.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

While about three billion endpoints are serviced by the major card processing networks, that is only about one half of world's adults with bank accounts. Some countries have low payment card penetration or have regulatory restrictions that limit payment instrument usage.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

In some embodiments, a system allows financial transfers between endpoints that are outside a traditional card-based financial system. A set of application program interfaces (APIs) allow non-card payment instructions to be generated and routed between endpoints over networks previously restricted to card payment processing only. A single send payouts API provides domestic and cross-border payout options to both card-based recipient endpoints and non-card based recipient endpoints. A payouts service provider (PSP) may be assigned a pseudo or token bank identification number (BIN) for the purpose of having a routable destination in the system. The PSP may then use its own information about a participating recipient to transfer funds to the recipient's account.

For new endpoints, minimum information for anti-money laundering (AML) and know your customer (KYC) regulations may be required. Additionally, overall processing efficiency may be improved when a pre-check of an endpoint is performed. Therefore, prior to initiating a financial transaction, an endpoint inquiry may be sent to a recipient PSP to verify the account destination information as well as gather AML and KYC information. These data may be used to populate many required data fields for new customers as well as validate endpoint availability for all transfers. After this initial data gathering step, the actual transfer may be initiated.

### BRIEF DESCRIPTION OF THE DRAWINGS

FIG. 1 illustrates a system supporting extended reach payments in accordance with the current disclosure;

FIG. 2 is the system of FIG. 1 supporting return of undeliverable funds in accordance with the current disclosure;

FIG. 3 is an illustration of a user device supporting an interface for extended reach payments in accordance with the current disclosure;

FIG. 4 is a schematic representation of various application program interfaces (APIs) of the extended reach payments system in accordance with the current disclosure; and

FIG. 5 is a flow chart illustrating a method for routing payments to non-card based recipient endpoints using a card-based network in accordance with the current disclosure.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

A system that allows distribution of funds over a card-based transaction network uses assigned pseudo identities as a proxy that allows institutions outside a card-based network to send and receive payments to participating bank accounts or third party payment accounts, such as WeChat pay. Any number of Payment Service Provider/Payouts Service Provider (PSP) may each be assigned a pseudo bank identification number (BIN) that allows payments made via a card network to be routed to the PSP with additional instructions that allow the PSP to identify the requested endpoint.

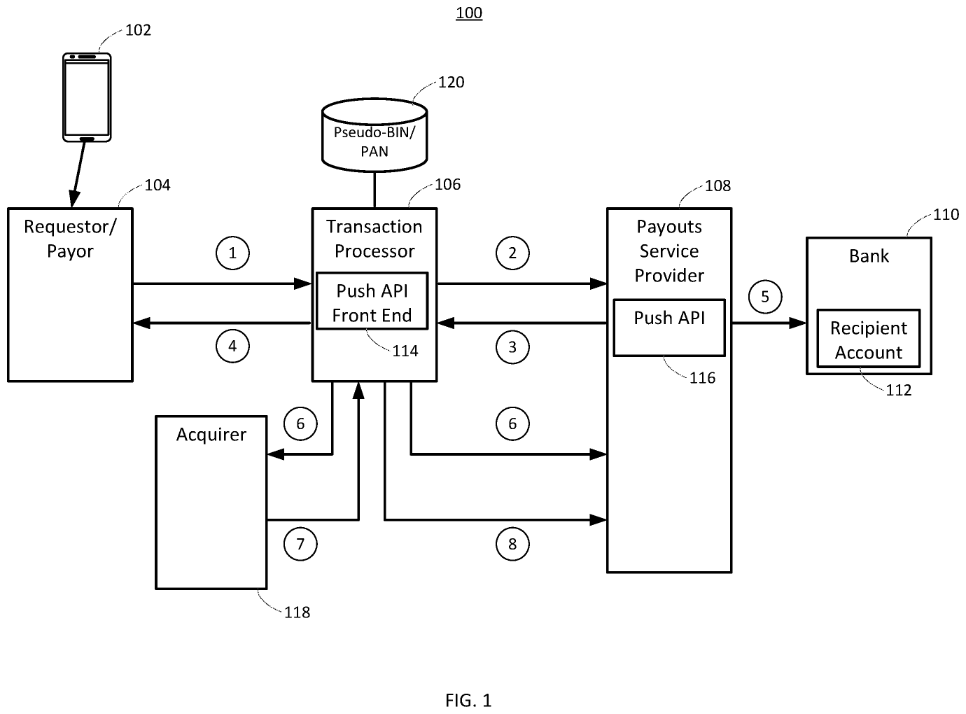

Turning to FIG. 1, an extended reach payments system 100 supporting financial transfers to non-card based endpoints is shown. The system 100 allows domestic and cross-border push-to-account payouts involved in, for example, money transfers to individuals or corporations, developer payouts, proceeds to sellers, contractor payments/payroll, insurance claim payouts, shared economy proceeds, merchant settlement payments, tax refunds, and remittance payments. The system 100 may include a user device 102, a requestor/payor 104, and a transaction processor 106. The transaction processor 106 may be a processor associated with a payment network such as VisaNet and/or Visa Direct. In some embodiments, the user device 102 may not be a separate unit, but may be an access point such as a web page hosted by the requestor/payor 104 or a corporate payment system.

A Payouts Service Provider (PSP) 108 may have a relationship with one or more banks 110 hosting one or more recipient accounts 112. In some cases, the bank 110 may be an alternate financial institution such as a digital wallet provider or other payment system. In some embodiments, the PSP 108 may be a financial service supporting cross-border payments, such as Earthport. An acquirer 118 may be a participant in the final settlement of the transaction. In some embodiments, the requestor/payor 104 and the acquirer 118 may be the same entity. As used herein, the “originator” is the requestor/payor 104 (or the acquirer 118 if the same entity) that connects with application program interfaces (APIs) of the transaction processor 106 to originate push-to-account payouts (see further details below). A database 120 that stores lookup information as well as onboarding data for non-standard endpoints may be used by the transaction processor 106 to identify when the requested endpoint, such as recipient account 112, requires extended handling.

Onboarding is the process of adding a client/PSP to the payment network. In an exemplary onboarding process, a PSP may be assigned its BIN. There may be one BIN per country/currency to be supported. A recipient base URL may also be required. This is a URL provided by the PSP to which HTTP messages may be sent. The client may also provide public domain and IP addresses that may be used by the transaction processor for an approved list to which to send traffic. The client may be provisioned with IP addresses from which to expect traffic for firewall setup. Security information such as key identifiers and one or more shared secret keys may be provisioned for encryption, decryption, and signing. In some cases, the establishment of communication between the parties may involve mutual SSL authentication based on a root and intermediate certificates tied to a trusted certificate authority (CA).

The database 120 may also serve as an onboarding database and may be used to store information previously gathered about PSPs and individual recipients including local and foreign government restrictions. Onboarding may include not only assignment of a BIN to a PSP, but also assignment of a virtual PAN to the PSP for use as a proxy in an existing transaction, allowing routing to the correct PSP. The pseudo-BIN/pseudo-PAN combination allows reuse of existing rails for carrying transaction payloads between endpoints as well as for settling transactions.

In operation, a request 1 for funds transfer may be made to the transaction processor 106 with the request including sender and recipient details and one or more additional fields or a pseudo-BIN/pseudo PAN according to a send payout application program interface (API) or a push API front end 114. Although the following discussion focuses on funds transfer to non-card based endpoints, the send payout API/push API 114 may be a single unified API that receives funds transfer requests and assists in pushing funds to both card-based and non-card based accounts. The transaction processor 106 may consult the database 120 to allow qualification of the requested endpoint. In some embodiments, the request may include only a recipient identifier and the transaction processor 106 may be responsible to identify the PSP 108 associated with a particular endpoint.

The transaction processor 106 may access a second push API 116 associated with the PSP to populate a push message to the PSP 108. As discussed above, the PSP 108 may have been through an onboarding process that sets up access points and cryptographic security for use with the transaction messages. The PSP 108, in near real time, may check its information about the recipient account 112 for account status and recipient details, in some embodiments, to return 3 a response to the transaction processor 106 acknowledging the request and providing an estimated posting date. The return response from the PSP 108 may ultimately be sent 4 to the requestor/payor 104.

Just as PSP's require onboarding, some transaction endpoints may also require onboarding which is a process that may require an initial participant to fill out a significant amount of detail related to end recipient details. These may include AML and KYC information for regulatory compliance. In addition, even previously approved recipients may have had changes to an account, been added to a watchlist, or have other factors that may affect the ability to deliver a payment. To address this problem, a look-ahead query may be presented that allows a number of those details to be returned to the originator, including account verification, legal status, routing information and some regulatory data. The look-ahead query, unlike a simple credit hold transaction, returns more than an issuer approval for funds, but may include data from the PSP about the intended recipient. This data may then be used for onboarding and subsequent account verifications and thereby greatly decrease the rate of rejected transactions.

Further information about the request and response are detailed below in Tables 1-3. The PSP 108, based on the information in the request, and having found no abortive information about the recipient account 112 may issue 5 the funds. Exemplary code for a request message for funds transfer including payment and recipient details is shown below.

```
{
“transactionDetail” : {
  “amount” : 500
  “statementNarrative” : “Visa Direct Payment”,
  “transactionCurrencyCode” : “840”,
  “transmissionDateTime” : “2019-12-29T13:24:03”,
  “businessApplicationId” : “FD”,
},
“recipientDetail” : {
  “type”: “I”,
  “firstName” : “Joe”,
  “lastName” : “Anderson”,
  “bank” : {
    “bankName” : “HSBC”,
    “accountName” : “Joe Anderson”,
    “accountNumber” : “1234567”,
    “countryCode” : “GBR”,
    “bankCode” : “400317”,
    “currencyCode” : “826”
    “accountType” : “SA”
  }
}
```

Exemplary code for a response message indicating successful authorization, destination amount, and expected posting date to recipient's account is shown below.

```
{
  “originatorDetail” : {
    “acquiringBin” : 400956,
    “merchantId”: “1st Direct Payouts Co.”
  },
  “serviceProviderDetail” : {
    “routingId” : “4065970026107365”
  },
  “transactionDetail” : {
    “transactionAmount” : 500,
    “transactionCurrencyCode” : “840”,
    “transmissionDateTime” : “2019-12-29T13:24:03”,
    “destinationAmount” : 448,
    “destinationCurrencyCode” : “978”,
    “authId” : “989898”,
    “responseCode” : “00”,
    “expectedPostingDate” : “2019-12-30”,
    “retrievalReferenceNumber” : “534855543229”,
    “systemTraceAuditNumber” : “6857854”,
    “transactionIdentifier” : “117189030153191”
  }
}
```

Approved payouts may be sent to a settlement service. Settlement may occur after the transaction, following a normal (business as usual) settlement process where information about the transaction is shared 6 with an acquirer 118 and the PSP 108. After which, the funds may be transferred 7 from the acquirer 118 to the transaction processor 106 and subsequently transferred 8 to the PSP 108.

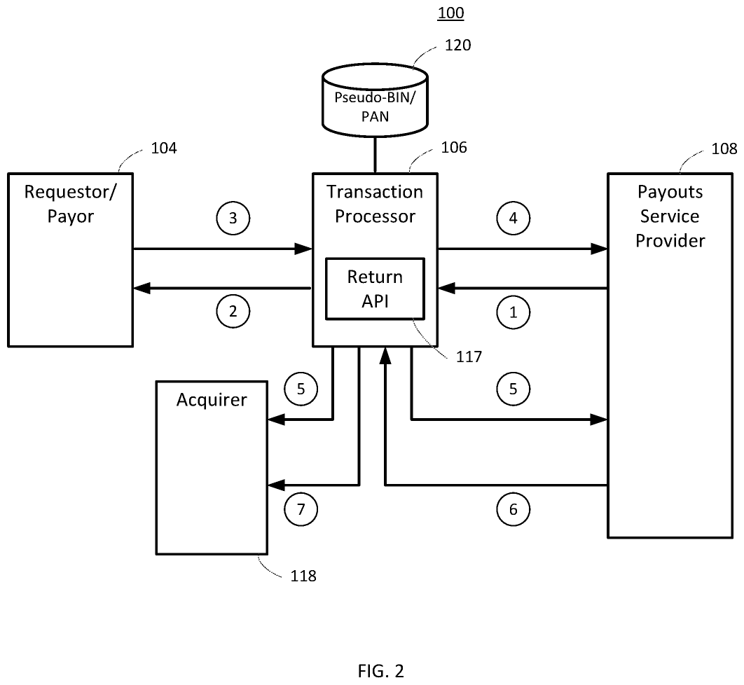

FIG. 2 illustrates an exemplary process for returning funds to the requestor/payor 104 in the event the PSP 108 cannot complete the transfer of funds. Exemplary elements of a return API 117 and related message contents are discussed in more detail below in Tables 4-6. The PSP 108 may request a return by sending 1 a message to the transaction processor 106 via the return API 117. The transaction processor 106 may forward 2 the return message to the requestor/payor 104, for example, using the original account and transaction data generated during the original request. Return messages sent 3 to the transaction processor 106 and sent 4 to the PSP 108 may confirm the return transaction. The return message may provide a reason for the return, such as ‘account closed’ so that the database 120 may be updated regarding that recipient endpoint. As before, the settlement process may follow business as usual processing with messages sent 5 to both parties with the actual funds transferred 6 to the transaction processor and transferred 7 to the acquirer 118.

Several interfaces may be used for accomplishing extended reach funds transfers. A front-end API or send payouts API 114 may expose methods for receiving payment instructions for non-card transactions while still using existing messaging and settlement systems. Transactions may be processed between card networks, automated clearing house (ACH) networks, real-time transport protocol (RTP) networks, and digital wallet networks.

The receive-side Original Credit Transaction (OCT) API that enables push funds to card accounts may be expanded to include additional fields supporting transfers to non-card accounts via PSPs to provide the send payouts API. The additional fields may be parsed from those OCT fields not necessarily applicable to the payment.

Because a delay between transaction acceptance and settlement may still exist, an API may be developed to allow the modified OCT transaction supported by the API above to be reversed if at some point the transaction fails to settle. Such cases may include closing of the recipient account or a regulatory ban on the account, to name just two such reasons.

Advanced routing logic allows routing non-card payment instructions to PSP's based on various criteria including cost, country coverage, and delivery payment timeliness. This routing may be aided by the assignment of pseudo-BINs to the PSPs participating in the system. A pseudo-PAN may be assigned to the endpoint, associated with the PSP in the same way a PAN of a card holder may be associated with an issuer. For example, a non-card payment message may be routed to a PSP using its BIN while the payload may contain more than a prior card-based transaction to include client-specific information used by the PSP to complete the payment. The routing logic may base routing decisions on information such as, Sender country, Recipient country, Currency, BAI (transaction code), Amount, Payout method, and Merchant (CAID), if any. Digital wallet credentials may increase the number of fields over a current OCT payment payload.

An API hosted by a PSP may allow transaction requests to be received on behalf of a constituent, where the PSP then completes the payment and is responsible for the settlement of the transaction. The API may accept JSON requests using, for example, an HTTP Post method. In an embodiment, the elements of such an API may include, for the original request, exemplary methods shown below (see Table 1). API fields may include, for example, bank ID, bank country code, bank name, originator ID, originator name, merchant category code, bank address, amount, transaction currency code, local transaction date and time, first and last name if the recipient is an individual, company name if the recipient is a company, and recipient address. In each case, information beyond what is described may be present in the actual implementation.

TABLE 1

| | Data | |
|---|---|---|
| Field name | type | Content/remarks |
| originatorDetail | Object | Object that contains originator details |
| | | May include BIN of sponsoring bank, |
| | | merchant/program ID that is sending |
| | | the payment, country code, or MCC. |
| service- | Object | Object that contains details of the |
| ProviderDetail | | service provider |
| | | May include ID for identifying and |
| | | routing the request to the PSP |
| transaction- | Object | Object that contains transaction |
| Detail | | details |
| | | May include amount to be paid, |
| | | currency, settlement date, origination |
| | | date/time, or type of transfer |
| | | (disbursement, account-to-account, |
| | | person-to-person). |
| recipientDetail | Object | Object that contains recipient detail |
| | | May include flag for individual or |
| | | company, name, date of birth, |
| | | address, bank name, account |
| | | number and type, country code, or |
| | | recipient bank's currency code. |
| senderDetail | Object | Object that contains the sender details |
| | | May include sender name, date of |
| | | birth, place of birth, or current |
| | | address. |

API responses may include details provided by the PSP, including several fields repeated from the initial request (see Table 2).

TABLE 2

| | Data | |
|---|---|---|
| Field name | type | Content/remarks |
| originatorDetail | Object | Object that contains originator details |
| | | May include BIN value from request |
| | | message |
| service- | Object | Object that contains details of the |
| ProviderDetail | | service provider |
| | | May include routingID from request |
| | | message |
| transaction- | Object | Object that contains PushToAccount |
| Detail | | transaction details |
| | | May include a code indicating the |
| | | result of the payout request (see |
| | | Table 3), an estimated recipient |
| | | payout date, or other transaction |
| | | details included in the request |
| | | message. |

A response code received at the push API 114 (or another API) from the push API 116 may provide code indicating the success or failure of a requested transaction, examples of which are shown in Table 3. Other success or failure codes may be included in the response in actual implementation.

TABLE 3

| Code | Description |
|---|---|
| 00 | Approved and completed successfully |
| 12 | Invalid transaction |
| 13 | Invalid amount |
| 14 | Invalid account number (no such number) |
| 57 | Transaction not permitted to cardholder |
| 61 | Exceeds approval amount limit |
| 64 | Transaction does not fulfill AML requirement |
| 65 | Exceeds velocity limits |
| 91 | Transaction timeout |
| 93 | Transaction cannot be completed - violation of law |
| 94 | Duplicate transmission. |
| T2 | Invalid Routing Transit Number |

Should a transaction be unsuccessful, the PSP 108 may request to return the funds to the originator via a return API 117. The return API 117 exposes methods for indicating the transaction to be refunded and, if available, the reasons (see Table 4 below).

TABLE 4

| | Data | |
|---|---|---|
| Field function | type | Content/remarks |
| service- | Object | Object that contains details of |
| ProviderDetail | | the Service Provider |
| | | May include the service provider |
| | | assigned BIN and the routingID |
| | | from the original request. |
| originatorDetail | Object | Object that contains originator details |
| | | This may include originator details |
| | | from the original transaction. |
| transactionDetail | Object | Object that contains transaction details |
| | | This may include the value and |
| | | reference number of the original |
| | | payment, currency code, and reason |
| | | for the return (see Table 5). |

The transaction detail object in the return API may include a reason for the return. Exemplary codes providing reasons for return are shown below in Table 5.

TABLE 5

| Code | Description |
|---|---|
| RE101 | The account not found |
| RE102 | The bank could not be located using |
| | the bank information provided |
| RE103 | The beneficiary name does not match |
| | the account owner's name |
| RE104 | The amount is higher than the limit |
| RE105 | The ID number provided to identify the |
| | beneficiary does not match the owner |
| | of the account |
| RE106 | Missing sender data |
| RE107 | Missing beneficiary data |
| RE201 | Returned due to regulatory reason |
| RE202 | The account has been restricted |
| RE203 | The recipient bank rejected the transfer |
| RE204 | The account has been closed |
| RE205 | The payment was not accepted by the |
| | recipient bank since it is not permitted |
| | as per a regulation or policy |
| RE206 | The recipient bank returned the payment |
| | since it is a duplicate |
| RE207 | The recipient did not accept the payment |
| RE208 | No reason provided |
| RE301 | The payment was returned based on a |
| | good faith request from sending bank |

Responses to the request to return funds may include the API methods exemplified in Table 6 below.

TABLE 6

| | Data | |
|---|---|---|
| Field name | type | Content/remarks |
| originatorDetail | Object | Object that contains |
| | | ReturnPushToAccount originator details |
| | | May use details from the return request. |
| service- | Object | Object that contains |
| ProviderDetail | | ReturnPushToAccount transaction details |
| | | May be the same value as the return |
| | | request. |
| transaction- | Object | Object that contains transaction details |
| Detail | | May include various details from the |
| | | return request and a transaction date/time. |

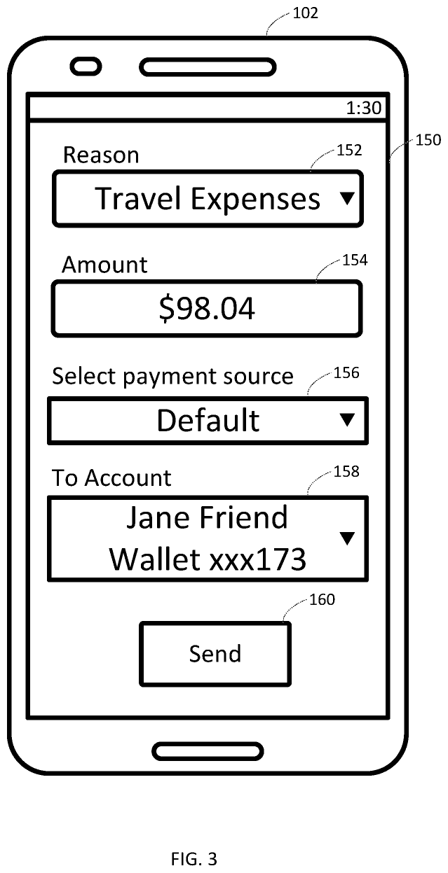

FIG. 3 is an exemplary embodiment of a user device 102 illustrating a user interface suitable for use with the extended reach system and method. The user device 102 may include a touch screen 150 supporting various data input fields via a funds transfer application (not depicted). A ‘reason’ field 152 may allow the user to select a reason for sending the funds. These reasons may align with the reasons from a predetermined list or the entry may be freeform. In some countries, a fixed list of reasons may be required to allow AML checks on the transaction. An amount field 154 may indicate the amount to be transferred. The currency may also be indicated by the identifier on the amount, e.g., $, €, £, etc.

A source field 156 may be used to designate a source of funds for the transfer. As indicated in the illustration, a default source may be set up, such as a bank account. In other embodiments, accounts from wallets or payment services may be uses as a source just as destination accounts may not be associated with a card issuer/acquirer. The ‘To Account’ field 158 may allow selection from a list although in other embodiments, free form entry of an account alias or account details may be supported. Once the entry data is entered, the ‘send’ button 160 may be used to initiate the transaction. The funds transfer application may include local field qualifiers, remote field qualifiers, or both. That is, data that has been entered may be checked for consistency and conformance to input formatting criteria as well as qualitative checks such as the source account having sufficient funds for the designated transfer amount. For example, a lookup module may access the requestor/payor 104 so that a determination may be made of the pseudo-BIN of the PSP 108.

Location optimizations may allow lower costs and quicker delivery by utilizing region, country, currency, and PSP information to select better routes for transactions and settlements. Both the source and destination characteristics are factored into decisions about routing, prepayments, and settlement choices.

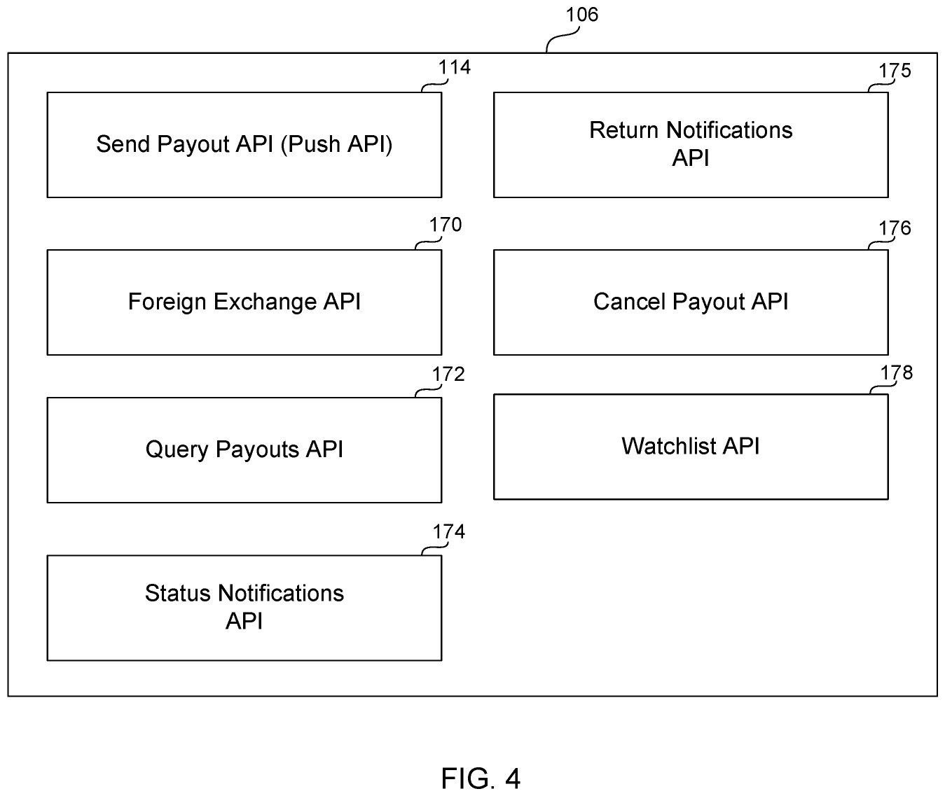

A schematic representation of various APIs available on the transaction processor 106 or another server or processor of the extended reach system 100 is shown in FIG. 4. The various APIs support the payout services of the extended reach system 100, and define interactions between the originator or the PSP and the transaction processor 106 for initiating and managing push-to-account payouts. The send payout API (or push API) 114 includes protocols for performing the functions described above including receiving requests for funds transfer to both card-based and non-card based recipient endpoints, and for pushing funds to the recipient endpoints. A foreign exchange API 170 includes protocols for using current foreign exchange rates to determine the amount of funds to be transferred to the recipient endpoint in the destination country currency if the destination account is foreign. A query payouts API 172 includes protocols allowing the originator to proactively request the status of an existing payout, and a status notifications API 174 includes fields to communicate interim status details of an existing payout request to the originator. Exemplary status indicators for an existing payout request are listed in Table 7. An exemplary status message code for providing a notification for a change of status of an existing payout request is also provided below.

```
{
  “originatorDetail” : {
    “acquiringBin” : 400956,
    “merchantId” : “1st Direct Payouts Co.”
  },
  “serviceProviderDetail” : {
    “routingId” : “4065970026107365”
  },
  “transactionDetail” : {
    “status” : “PAYMENT_SENT”
    “transmissionDateTime” : “2019-12-29T15:19:09”,
    “retrievalReferenceNumber” : “534855543229”,
    “systemTraceAuditNumber” : “6857854”,
    “transactionIdentifier” : “117189030153191”
  }
}
```

TABLE 7

| Status | Description |
|---|---|
| Payment_Received | Payout has been accepted and is |
| | currently being processed. Expected |
| | posting date provided to Originator along |
| | with the destination amount. |
| | The payment is cancelable via the cancel |
| | payout API during this status only. |
| Payment_Sent | Payout has been sent and successfully |
| | accepted by the partner bank. |
| | Status notification sent with the expected |
| | posting date to recipient account. |
| Declined | Payout declined in real-time flow due to |
| | a validation failure (missing mandatory |
| | fields, etc.). |
| Returned | Payout returned back to the Originator - |
| | either due to a request for cancelation or |
| | recall, a compliance related reject, or due |
| | to the partner bank sending back as a |
| | return. |
| | Return notification sent to Originator. |
| Awaiting_Info | Payout is pending additional information |
| | from Originator (due to compliance |
| | reasons). Status notification sent to |
| | Originator. |

A return notifications API 175 includes protocols that allow the originator to receive notifications about payouts that get returned or rejected and the reasons for the return (see Table 5). A cancel payout API 176 includes protocols that allow the originator to request cancelation of an existing payout request provided the payout is still being processed. Responses to requests for cancelation include: 1) cancelation successful (payout has been returned), 2) cancelation request pending (not yet confirmed), and 3) cancelation unsuccessful. Additionally, a watchlist API 178 includes protocols for screening the payment sender and the recipient against global watchlists.

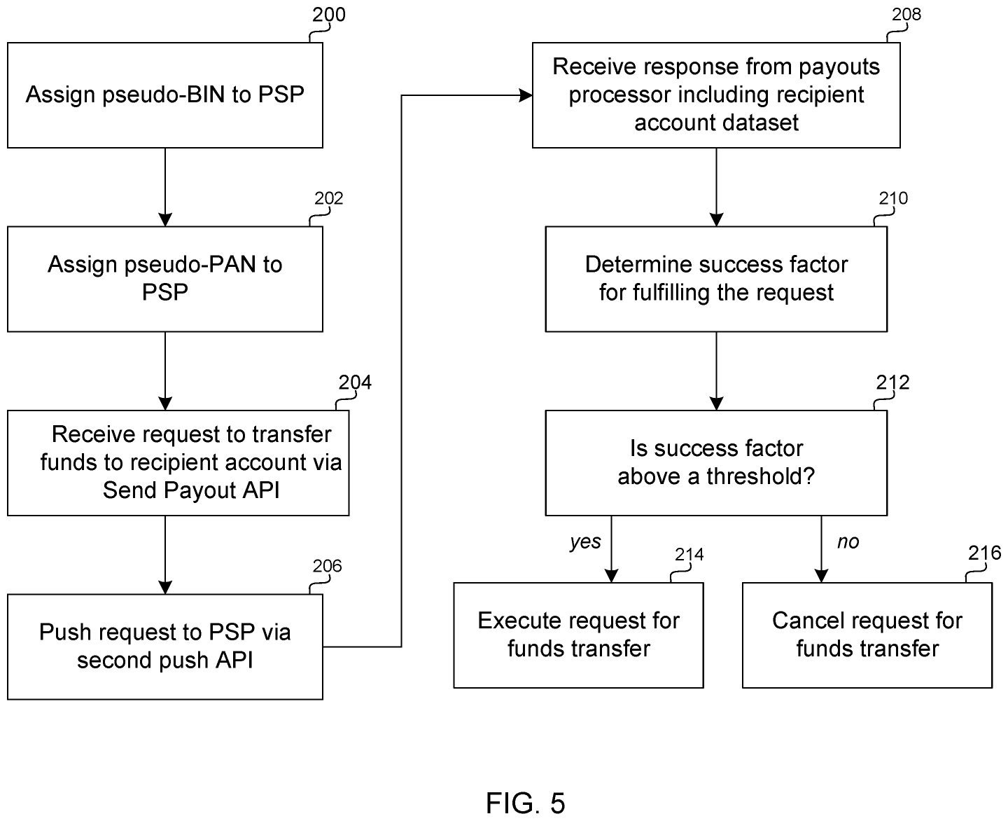

Turning to FIG. 5, a method for routing a payment to non-card based recipient endpoint as performed at the transaction processor 106 is shown. At blocks 200 and 202, a pseudo-BIN and a pseudo-PAN may be assigned to the PSP 108 supporting payouts to the non-card based recipient endpoint. At a block 204, the send payout API (first push API) 114 may be exposed to receive a request to transfer funds to a selected non-card based recipient account associated with the PSP 108. At a next block 206, the request to transfer funds may be pushed to the second push API 116 associated with the PSP 108. At a block 208, a response message may be received from the PSP 108 and may include a recipient account dataset including information about the recipient account and the recipient account holder such as, but not limited to, AML information, KYC information, legal status of the recipient account holder, and recipient account details. The transaction processor 106 may assess such information in the recipient account dataset to determine a success factor for fulfilling the request for funds transfer to the recipient account at a block 210. If the success factor is above a threshold as determined at a block 212, the request for funds transfer may be executed (block 214). If the success factor is below the threshold, the request for funds transfer may be canceled (block 216).

A technical effect of the system and method of the present disclosure is the single, unified send payout API that includes fields to support domestic and cross-border financial transfers to both card-based accounts and non-card based accounts via PSPs, expanding the reach of the payment system. Multiple APIs are provided to support interactions between entities of the extended reach system to initiate and manage payouts to recipient endpoints. Another technical effect of the system and method of the present disclosure is the return of data by the destination PSP for use by the initiator to complete AML and KYC information, among others, for the onboarding process at the requestor/payor side. Another technical effect is the ability to pre-qualify the endpoint prior to a funds transfer being initiated. Yet another technical effect is the use of card-based payment rails for non-card based endpoints, such as simple bank accounts.

These techniques benefit both networks and end users. Networks may expand the endpoints available for transactions while end users may as much as double the destinations available for making payments for goods and services.

The figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of routing payments to non-card based entities using a card-based network, the method comprising:
assigning a pseudo-bank identification number (pseudo-BIN) to a payouts service provider supporting endpoints without financial card accounts;
assigning a pseudo-primary account number (pseudo-PAN) to the payouts service provider;
exposing a send payout application program interface (API) that receives a request to transfer funds to a recipient account of an account holder, wherein the send payout API comprises fields to communicate:
a payment amount;
a sending account; and
a recipient account;
parsing the request to determine the pseudo-PAN;
determining the payouts service provider based on the pseudo-PAN;
generating a look-ahead query to the payouts service provider using the pseudo-BIN associated with the pseudo-PAN;
receiving from the payouts service provider a response to the look-ahead query, the response including a recipient account dataset;
assessing the recipient endpoint dataset to determine a success factor for the fulfilling the request to transfer funds;
responsive to the success factor exceeding a predetermined threshold, preparing a transaction payload including data from the recipient endpoint dataset; and
executing the transfer using the transaction payload.

2. The method of claim 1, further comprising exposing a received response application program interface (API) wherein the received response API comprises fields to communicate:
payouts that were returned; and
payouts that were rejected.

3. The method of claim 2, wherein the received response comprises a code which indicates one selected from a group comprising:
approved and completed successfully;
invalid transaction;
invalid amount;
invalid account number (no such number);
transaction not permitted to cardholder;
exceeds approval amount limit;
transaction does not fulfill requirement;
exceeds velocity limits;
transaction timeout;
transaction cannot be completed—violation of law;
duplicate transmission; and
invalid routing transit number.

4. The method of claim 2, wherein the received response comprises a code indicating a reason for a payout return including one selected from a group comprising:
an account not found;
a bank could not be located using bank information provided;
a beneficiary name does not match an account owner's name;
an amount is higher than a limit;
an identification number provided to identify the beneficiary does not match an owner of the account;
missing sender data;
missing beneficiary data;
returned due to regulatory reason;
an account has been restricted;
a recipient bank rejected the transfer;
an account has been closed;
a payment was not accepted by a recipient bank since it is not permitted as per a regulation or policy;
a recipient bank returned the payment since it is a duplicate;
a recipient did not accept the payment;
no reason provided; and
a payment was returned based on a good faith request from sending bank.

5. The method of claim 1, further comprising exposing a status notifications application program interface (API), wherein the status notifications API comprises a field to communicate interim status details.

6. The method of claim 5, wherein the status details include an indication that the transfer request has been received and is being processed, an indication that a payout has been sent to the recipient account, an indication that the transfer request is declined, an indication that the payout has been returned to the sending account, or an indication that the transfer request is pending additional information.

7. The method of claim 1, wherein the recipient endpoint dataset comprises onboarding data including identity information and a legal status of the recipient account holder.

8. The method of claim of 7, wherein the recipient endpoint dataset comprises anti-money laundering information.

9. The method of claim 7, wherein the recipient endpoint dataset comprises know your customer information.

10. The method of claim 1, wherein assessing the recipient endpoint dataset comprises identifying a closed account message in the dataset.

11. The method of claim 1, wherein assessing the recipient endpoint database comprises identifying a legal hold message in the database.

12. A computer-implemented method for routing payments to non-card based recipient endpoints using a card-based network, comprising:
assigning a pseudo-bank identification number (pseudo-BIN) to a payouts service provider supporting payouts to non-card based recipient endpoints without financial card accounts;
assigning a pseudo-primary account number (pseudo-PAN) to the payouts service provider;
exposing a first push application program interface (API) that receives a request to transfer funds to a recipient account, the recipient account being a non-card based endpoint associated with the payouts service provider, wherein the request to transfer funds includes fields to communicate:
a payment amount;
a sending account;
the recipient account; and
the pseudo-BIN and the pseudo-PAN;
pushing the request to transfer funds to a second push application program interface (API) associated with the payouts service provider;
receiving a response from the payouts service provider, the response including a recipient account dataset associated with the recipient account;
assessing the recipient account dataset to determine a success factor for fulfilling the request to transfer funds to the recipient account; and
executing the request to transfer funds responsive to the success factor exceeding a predetermined threshold.

13. The computer-implemented method of claim 12, wherein the recipient account dataset includes anti-money laundering information.

14. The computer-implemented method of claim 12, further comprising exposing the first push API that receives the response from the payouts service provider, wherein the response received from the payouts service provider comprises a response code indicating one or more of the following:
approved and completed successfully;
invalid transaction;
invalid amount;
invalid account number (no such number);
transaction not permitted to recipient account;
exceeds approval amount limit;
exceeds velocity limits;
transaction timeout;
transaction cannot be completed—violation of law;
duplicate transmission; and
invalid routing transit number.

15. The computer-implemented method of claim 12, further comprising exposing a return application program interface (API) that receives a return request message from the payouts service provider when the payouts service provider cannot complete the request for funds transfer to the recipient account, the return request message including a request to return funds to the sending account and a reason for the return of funds to the sending account.

16. The computer-implemented method of claim 12, further comprising exposing a watchlist application program interface (API) that screens the sending account and the recipient account against global watchlists.

17. The method of claim 12, further comprising exposing a cancel payout application program interface (API) that receives a request to cancel the request to transfer funds to the recipient account.

18. A system for routing payments to non-card based recipient endpoints, comprising:
a requestor/payor;
a payouts service provider supporting payouts to non-card based recipient endpoints without financial card accounts; and
a transaction processor configured to execute computer-executable instructions for:
assigning a pseudo-bank identification number (pseudo-BIN) to the payouts service provider;
assigning a pseudo-primary account number (pseudo-PAN) to the payouts service provider;
exposing a first push application program interface (API) configured to receive a request to transfer funds to a recipient account from the requestor/payor, the recipient account being a non-card based endpoint associated with the payouts service provider, wherein the request to transfer funds includes fields to communicate:
a payment amount;
a sending account;
a recipient account; and
the pseudo-BIN and the pseudo-PAN;
pushing the request to transfer funds to a second push application program interface (API) associated with the payouts service provider;
receiving a response from the payouts service provider, the response including a recipient account dataset associated with the recipient account;
assessing the recipient account dataset to determine a success factor for fulfilling the request to transfer funds; and
executing the request to transfer funds responsive to the success factor exceeding a predetermined threshold.

19. The system of claim 18, wherein the transaction processor is further configured to execute computer executable instructions for exposing a return application program interface (API) that receives a return request message from the payouts service provider when the payouts service provider cannot complete the request for funds transfer to the recipient account, the return request message including a request to return funds to the sending account and a reason for the return of funds to the sending account.

20. The system of claim 18, wherein first push API is a single unified API that receives requests to transfer funds to both card-based and non-card based recipient endpoints.
